(19) United States
(12) Patent Application Publication
(10) Pub. No.: US 2007/0250701 A1
(43) Pub. Date: Oct. 25, 2007

(54) System and method for performing efficient program encoding without splicing interference

(75) Inventor: Fabrice M.R. Quinard, Los Gatos, CA (US)

Correspondence Address: THELEN REID BROWN RAYSMAN & STEINER LLP, P. O. BOX 640640, SAN JOSE, CA, 95164-0640, US

(73) Assignee: Terayon Communication Systems, Inc.

(21) Appl. No.: 11/411,078

(22) Filed: Apr. 24, 2006

(51) Int. Cl. H04L 9/00

(52) U.S. Cl. 713/150

(57) ABSTRACT

Multiple-frame format data streams are selectively encrypted at a master head-end prior to distribution. Selective encryption includes monitoring packet for frame header information. Only packets that do not contain frame header information are encrypted, while those that contain frame header information are left unencrypted. Splicers at distribution hubs can then interject local content into the data streams and forward these to individual subscribers at the local node groups.

### CROSS-REFERENCE TO RELATE APPLICATIONS

(Not applicable)

### BACKGROUND OF THE INVENTION

1. Field of the Invention

The invention relates to multiple-frame format data stream encryption.

2. Description of the Related Art

FIG. 1 is an architectural diagram of a conventional program distribution system 10. At master head-end 11 is disposed a program aggregation device 12 for combining signals from a plurality of IRD encoders such as satellite receivers or MPEG encoders 14. Aggregation device 12, and possibly others like it (not shown) connected by way of a local IP network (not shown), transmits its programming data to a distribution hub 21 with which is associated a plurality of node groups 28 (two are shown) each servicing one or more subscribers 24. The transmission medium is for example an inter-office IP distribution ring 22. At the distribution hub 21, a splicer 16 interjects local content into the data stream (for example, advertising, local news, and so forth) before the data steam reaches an encryption device 18, followed by a QAM (quadrature amplitude modulator) 20, and finally the subscribers 24. The local content interjected into the data stream originates at server 26.

The requirement of an encryption device 18 for each node group 28 is costly and inefficient. However, heretofore it has been perceived as necessary since encryption could not take place until local content from servers 26 was interjected into the data stream, which by definition has to occur locally at each node group. The alternative, which is to perform encryption as far upstream as at the headend, would require a complex frame reconstruction at the distribution hubs so that proper splicing of local programming from servers 26 could be performed. In particular, in order to properly carry out its function, the splicer 16 needs to recognize, analyze, and modify frame header information and other parameters for incoming data in the data stream. The splicer 16 needs to recognize PES (Packetized Elmentary Stream) headers in order to extract the PTS (Presentation Time Stamps) and DTS (Decoding Time Stamps) so that these time stamps can be re-stamped in such a manner that the transition between the incoming data stream and the local content will be seamless and not exhibit any timing discontinuities. The splicer needs to recognize GOP (Group Of Picture) headers in order to extract the information whether the GOP is “close” or “open”. The splicer also needs to recognize Picture Headers in order to extract picture information such as frame type (I, P, or B) in order to splice out and back in the data stream on specific frame types. For example splice out of the data stream on I or P frames only, and splice to the data stream on I frames only. The splicer 16 needs to extract the field polarity for each frame (top field or bottom field first). This information is useful to compensate for field polarity mismatch between the incoming data stream and the local content at splice points. Once all this is accomplished, local content from the server 26 can be injected into the data stream at the proper location and in harmony with the content of the data stream. Scrambling the header and other information in advance of the splicer 16 complicates the ability of the splicer to perform its functions, and necessitates a precursor reconstruction step to undo at least some of the scrambling process. To avoid this, encryption has conventionally been performed after splicing, necessitating placement of encryption devices 18 at each local site.

### BRIEF SUMMARY OF THE INVENTION

In accordance with an aspect of the invention, there is provided a method for encrypting a data stream. The method includes monitoring packets of the data stream to determine if they contain frame header information, and encrypting packets that do not contain frame header information.

In a further aspect of the invention, there is provided a method for handling multiple-frame format information in a data stream. The method includes packetizing the data stream, encrypting the packetized data stream, distributing the encrypted data stream, and interjecting local content into the distributed data stream.

In a further aspect of the invention, there is provided a selective encryption device. The device includes a packet monitor configured to determine the presence of frame header information in a packet, and an encryption module configured to encrypt a packet determined not to contain frame header information.

In a further aspect of the invention, there is provided a data stream distribution system. The system includes a selective encryption device configured to selectively encrypt an incoming data stream, and a splicer configured to interject local content into the selectively encrypted data steam.

In a further aspect of the invention, there is provided a device for encrypting a data stream. The device includes means for monitoring packets of the data stream to determine if they contain frame header information, and means for encrypting packets that do not contain frame header information.

In a further aspect of the invention, there is provided a system for handling multiple-frame format information in a data stream. The system includes means for packetizing the data stream, means for encrypting the packetized data stream, means for distributing the encrypted data stream, and means for interjecting local content into the distributed data stream.

### BRIEF DESCRIPTION OF THE SEVERAL VIEWS OF THE DRAWINGS

Many advantages of the present invention will be apparent to those skilled in the art with a reading of this specification in conjunction with the attached drawings, wherein like reference numerals are applied to like elements, and wherein:

FIG. 1 is an architectural diagram of a conventional program distribution system;

FIG. 2 is an architectural diagram of a program distribution system in accordance with a first aspect of the invention;

FIG. 3 is a schematic diagram of a typical information packet; and

FIG. 4 is a block diagram of a selective encryption device.

### DETAILED DESCRIPTION OF THE INVENTION

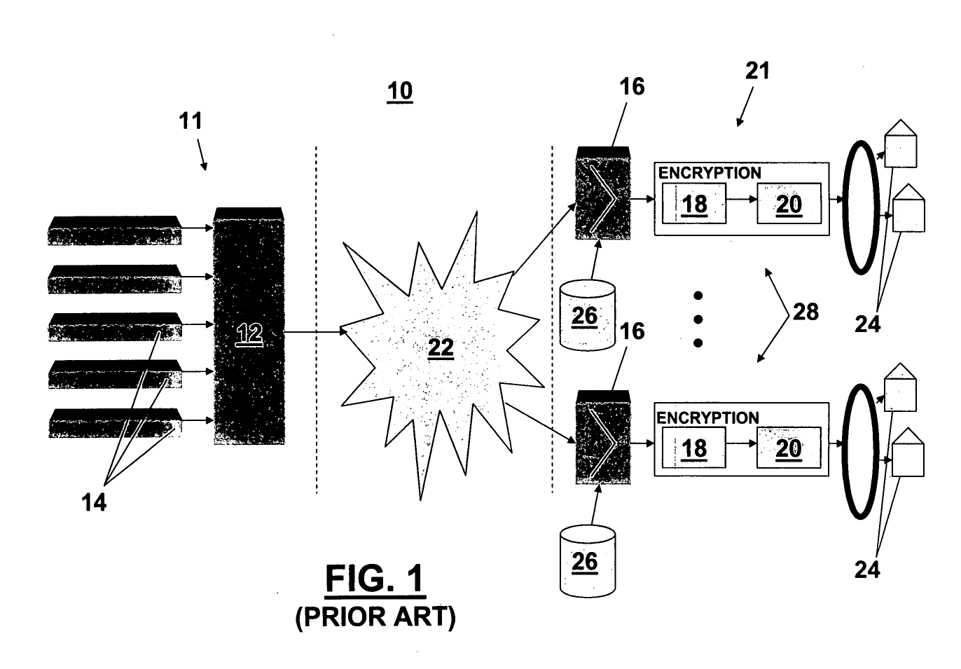

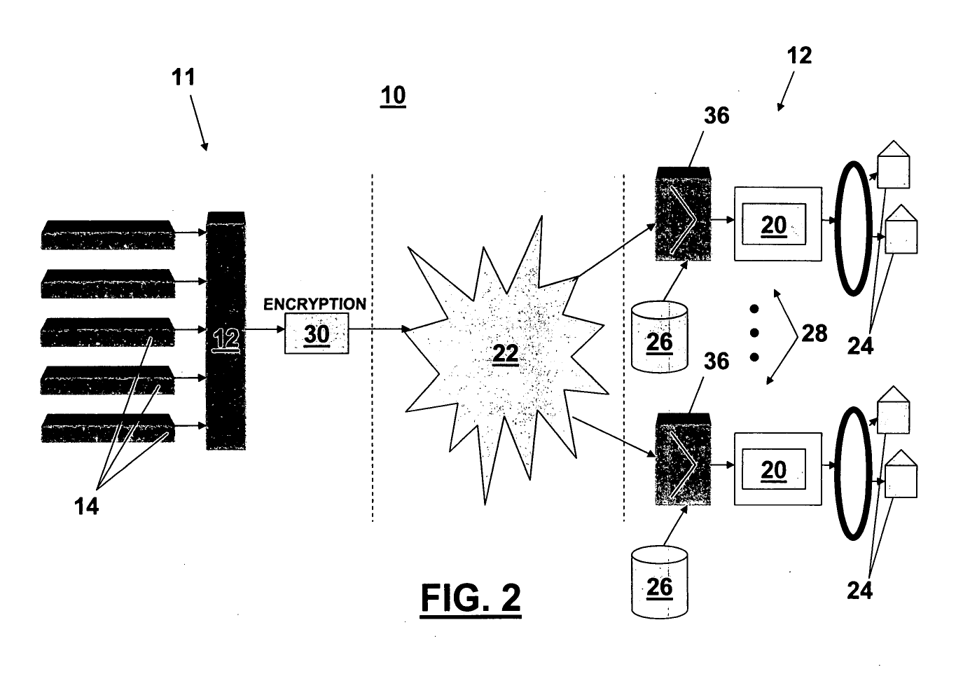

FIG. 2 is an architectural diagram of a program distribution system in accordance with the invention. In FIG. 2, selective encryption device 30 is interposed in the data stream at the master headend 11, replacing the plurality of such devices 18 at the distribution hubs 28 in the prior art system of FIG. 1. In accordance with this arrangement, the aggregated information from aggregator 12 is encrypted by the selective encryption device 30 at the headend 11 before transmission through network 22 to the network groups 28. However, this encryption is only partial, as the description below will make clear. The partially-encrypted information is transmitted to splicers 16 via IP network 22, where local content from servers 26 is added. The data streams then pass to QAMs 20 and on to the individual subscribers 24.

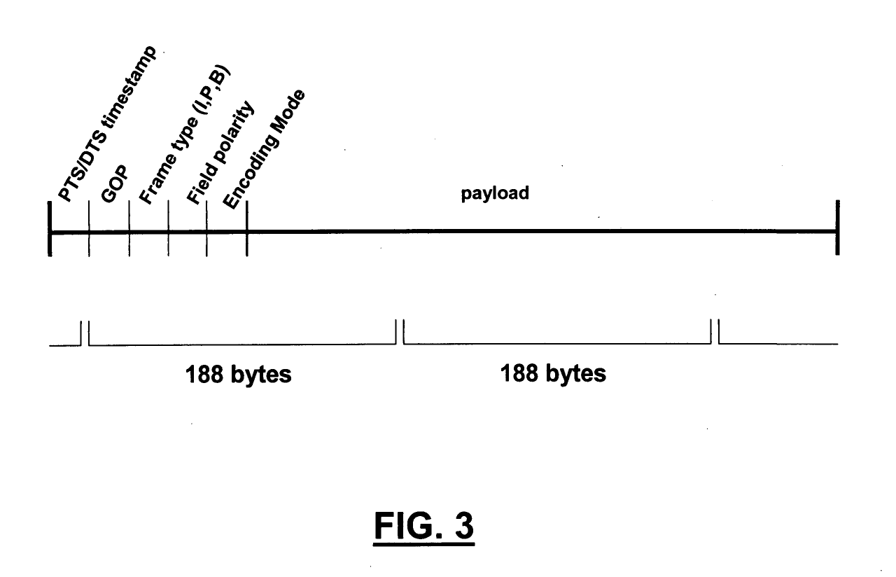

FIG. 3 shows the layout of an I-frame in accordance with the MPEG compression standard. It will be recalled that in the MPEG compression standard, three types of frames are used. The I-frames are intra-coded—that is, they can be reconstructed without any reference to other frames. The price for this is that they are typically the most information-intensive of the frames and accordingly consume the highest transmission resources. The P-frames are forward-predicted from the last I-frame or P-frame—that is, it is impossible to reconstruct them without the data of another frame (I or P). The B-frames are both forward-predicted and backward-predicted from the last/next I-frame or P-frame-that is, two other frames are necessary to reconstruct them. P- and B-frames are typically less dense than I-frames and consume less transmission resources. I-frames are also referred to as anchor frames and are used as the point of reference here because it is from the I-frames that a newly-tuned channel is initially constructed for viewing, and a splicer 36 uses the I-frames as the least disruptive point to interject content into the data stream. As can be seen from FIG. 3, an I-frame (or any other frame) can be distributed over several 188-byte packets transmitted over the network. A frame contains frame header information including, but not limited to, a PES header including PTS/DTS timestamps, a GOP header including close or open GOP information, Picture Header including frame type information, field polarity, frame or field encoding mode and so forth. In performing its splicing operations, the splicer 36 relies on this header information to determine the point at which local content is to be interjected into the data stream. By keeping this information intact while selectively encrypting other remaining information that is not relied upon by the splicer 36, the splicing function is not interfered with. In this manner, selective encryption can be performed upstream of the splicer 36. In particular, as seen in FIG. 2, encryption of a packetized data stream can take place using a single common selective encryption device 30, rather than a multiplicity of encryption devices each disposed at a downstream location from a local content server.

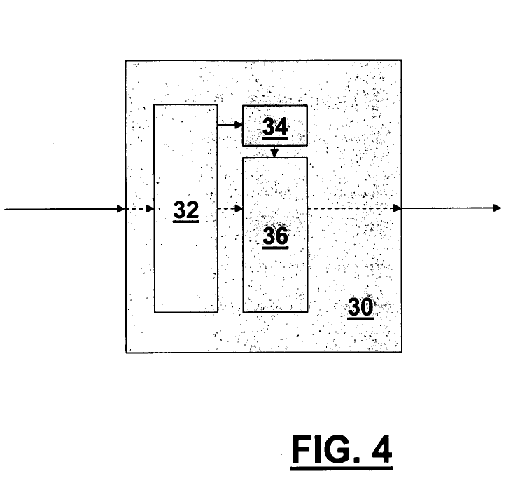

FIG. 4 is a schematic diagram of an selective encryption device 30. A packet monitor 32 examines incoming 188-byte packets for frame header information such as a PES header including PTS/DTS timestamps, a GOP header including close or open GOP information, Picture Header including frame type information, field polarity, frame or field encoding mode and so forth. A packet found to contain this information is left unencrypted. A packet marker 34 marks the unencrypted packet as unencrypted. This is effected by leaving the transport scrambling control bits in the packet marked as unencrypted. Conversely, a packet that is found by packet monitor 32 not to contained frame header information is encrypted by encryption module 36, and is marked accordingly by packet marker 34 by setting the transport scrambling control bits in the packet to indicate that packet is encrypted.

The above are exemplary modes of carrying out the invention and are not intended to be limiting. It will be apparent to those of ordinary skill in the art that modifications thereto can be made without departure from the spirit and scope of the invention as set forth in the following claims.

1. A method for encrypting a data stream comprising:
monitoring packets of the data stream to determine if they contain frame header information; and
encrypting packets that do not contain frame header information.

2. The method of claim 1, further comprising:
marking packets to indicate whether or not they are encrypted.

3. The method of claim 2, wherein said marking comprises:
causing transport scrambling control bits in a packet to indicate an unencrypted state.

4. A method for handling multiple-frame format information in a data stream, the method comprising:
packetizing the data stream;
encrypting the packetized data stream;
distributing the encrypted data stream; and
interjecting local content into the distributed data stream.

5. The method of claim 4, wherein said encrypting comprises:
monitoring packets of the data stream to determine if they contain frame header information; and
encrypting packets that do not contain frame header information.

6. The method of claim 5, further comprising:
marking packets to indicate whether or not they are encrypted.

7. The method of claim 6, wherein said marking comprises:
causing transport scrambling control bits in a packet to indicate an unencrypted state.

8. The method of claim 4, wherein encrypting is conducted at a master head-end.

9. The method of claim 4, wherein interjecting is conducted at a distribution hub.

10. A selective encryption device comprising:
a packet monitor configured to determine the presence of frame header information in a packet; and
an encryption module configured to encrypt a packet determined not to contain frame header information.

11. The device of claim 10, further comprising:
a packet marker configured to provide an indication that a packet is encrypted.

12. The device of claim 11, wherein the packet marker causes a transport scrambling control bit in a packet to indicate an encrypted state.

13. A data stream distribution system comprising:
a selective encryption device configured to selectively encrypt an incoming data stream; and
a splicer configured to interject local content into the selectively encrypted data steam.

14. The system of claim 13, wherein the selective encryption device comprises:
a packet monitor configured to determine the presence of frame header information in a packet of the data stream; and
an encryption module configured to encrypt a packet determined not to contain frame header information.

15. The system of claim 14, wherein the selective encryption device further comprises:
a packet marker configured to provide an indication that a packet is encrypted.

16. The system of claim 15, wherein the packet marker causes a transport scrambling control bit in a packet to indicate an encrypted state.

17. A device for encrypting a data stream comprising:
means for monitoring packets of the data stream to determine if they contain frame header information; and
means for encrypting packets that do not contain frame header information.

18. A system for handling multiple-frame format information in a data stream, the system comprising:
means for packetizing the data stream;
means for encrypting the packetized data stream;
means for distributing the encrypted data stream; and
means for interjecting local content into the distributed data stream.
